(19) United States
(12) Patent Application Publication
(10) Pub. No.: US 2013/0252216 A1
(43) Pub. Date: Sep. 26, 2013

(54) MONITORING PHYSICAL THERAPY VIA IMAGE SENSOR

(71) Applicants: John Clavin, Seattle, WA (US); Jaron Lanier, Berkeley, CA (US)

(72) Inventors: John Clavin, Seattle, WA (US); Jaron Lanier, Berkeley, CA (US)

(73) Assignee: MICROSOFT CORPORATION, Redmond, WA (US)

(21) Appl. No.: 13/425,147

(22) Filed: Mar. 20, 2012

(51) Int. Cl. G09B 19/00

(52) U.S. Cl. 434/257; 434/247

(57) ABSTRACT

Embodiments related to an interactive physical therapy experience are disclosed. One embodiment provides a computing device configured to receive, from an administrator client, an assigned exercise list comprising one or more assigned exercises to be performed by a user. The computing device is further configured to send, to a user client, one or more exercise modules, each of the exercise modules representing one of the assigned exercises. The computing device is further configured to receive prescription tracking data representing performance of the one or more assigned exercises by the user, and provide feedback to the administrator client based on the prescription tracking data.

### BACKGROUND

Physical therapy is a medical technique with many important uses. For example, physical therapy may be used to help patients recover from surgery or injury, cope with a disability, address balance issues, or even to simply allow a person to reach a higher level of physical activity. The effective practice of physical therapy involves skilled input from a practitioner, such as a physiatrist or physical therapist, during office visits to instruct patients how to perform assigned exercises correctly.

### SUMMARY

Embodiments are disclosed that relate to providing an interactive physical therapy experience. For example, one disclosed embodiment provides a computing device configured to receive, from an administrator client, an assigned exercise list comprising one or more assigned exercises to be performed by a user. The computing device is further configured to send, to a user client, one or more exercise modules, each of the exercise modules representing one of the assigned exercises. The computing device is further configured to receive prescription tracking data representing performance of the one or more assigned exercises by the user, and provide feedback to the administrator client based on the prescription tracking data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an example use environment for providing an interactive physical therapy experience.

FIG. 2 shows an example embodiment of a processing pipeline for analyzing performance of one or more assigned exercises.

FIG. 3 shows a process flow depicting an embodiment of a method for providing an interactive physical therapy experience for a patient via a user client device.

FIG. 4 shows a process flow depicting an embodiment of a method for providing an interactive physical therapy experience for a practitioner via an administrator client device.

FIG. 5 shows a process flow depicting an embodiment of a method for providing an interactive physical therapy experience via a network-based service accessible by a user client and an administrator client.

FIG. 6 schematically shows a computing system in accordance with an embodiment of the present disclosure.

### DETAILED DESCRIPTION

As mentioned above, physical therapy involves continual, skilled input from a trained professional (e.g., physiotherapist, physical therapist, or PTA) during performance of one or more assigned exercises. The physical therapist may have to demonstrate, view, and correct each of the assigned exercises. Such attention may help to ensure proper performance of the exercises and/or to measure patient progress. As such, the course of therapy may involve multiple office visits for the patient.

Due to the amount of time and attention required, traditional physical therapy may be slow and expensive. Therefore, embodiments are disclosed herein that may facilitate observation and feedback processes during a course of physical therapy. Briefly, the disclosed embodiments employ a depth camera and potentially other sensors to monitor patient performance of assigned exercises outside of the physical therapist office. In one example scenario, a person may initially be assigned exercises during an in-person consultation (e.g. with a physiatrist, physical therapist, personal trainer, coach, etc.), during which the person may receive instruction and in-person feedback regarding the performance of the exercises. Subsequent performances of the one or more assigned exercises may then be monitored via a depth camera while the person performs the exercises at home.

The use of a depth camera in combination with visual feedback based upon depth images capturing the user may allow a physical therapist and patient to observe whether exercises are being performed correctly, and also whether a patient is making progress, without the patient having to make an office visit. Further, rewards and incentives may be implemented as feedback to encourage a patient to maintain an exercise program. This may help to provide more efficient use of both therapist and patient time.

The use of machine vision in a physical therapy setting may provide additional potential benefits. For example, other technologies (e.g., wrist bands with accelerometers) may detect a small subset of motion (e.g., degree of arm extension) during performance of one or more exercises. Such technologies may be limited to a few concentrated data points (e.g., the arm and/or wrist) and may not be able to capture deficiencies/symptoms outside the scope of treatment (e.g., poor spinal posture during the exercise).

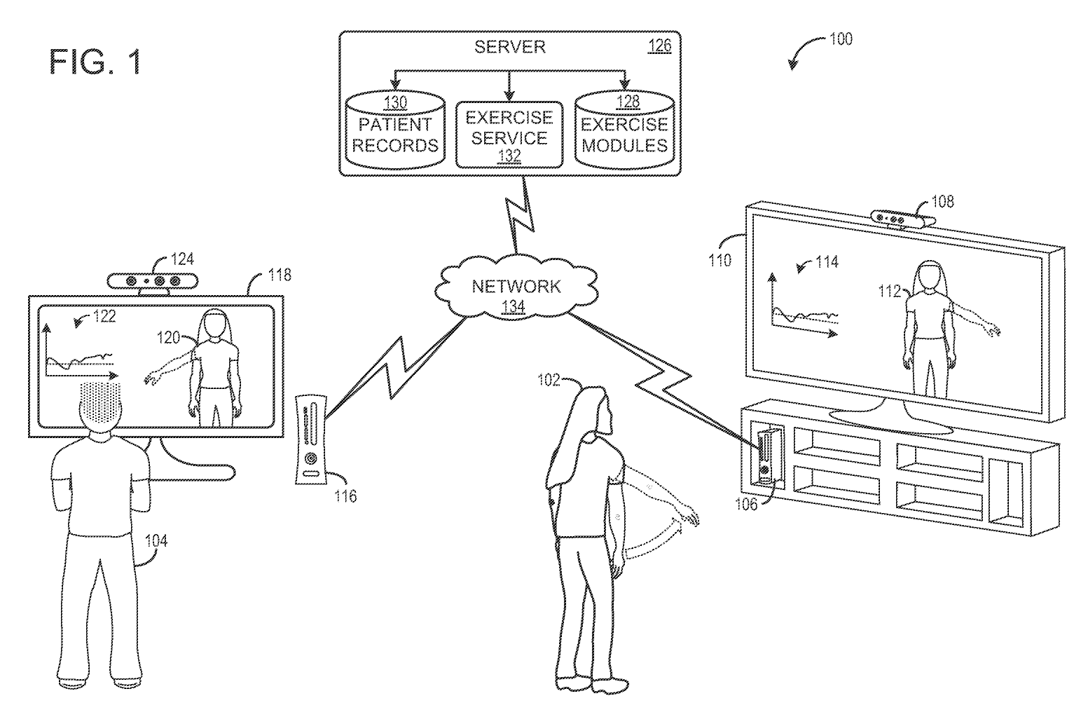

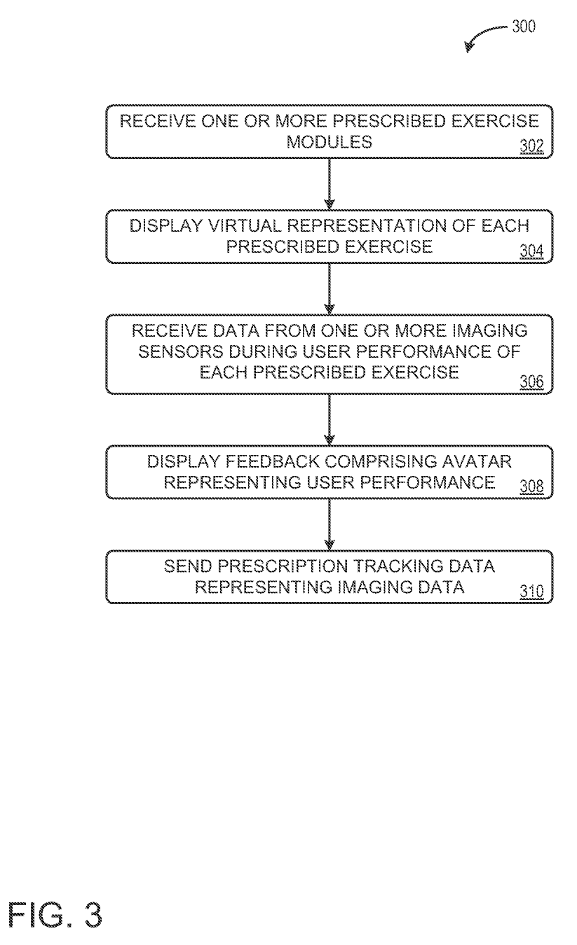

FIG. 1 shows an embodiment of an example use environment 100 for providing an interactive physical therapy experience. Use environment 100 comprises a user (e.g., a patient) 102 performing one or more exercises assigned by an administrator (e.g., a physical therapist, personal trainer, etc.) 104. The assigned exercises may be provided via an exercise list comprising one or more exercise modules, which will be discussed in greater detail below in reference to FIG. 3. As illustrated, user 102 is performing an exercise comprising raising and lowering an arm, which may be assigned, for example, for a shoulder injury. It will be understood that the term “exercise module” as used herein signifies any representation of a particular exercise for presentation to a patient via a display device.

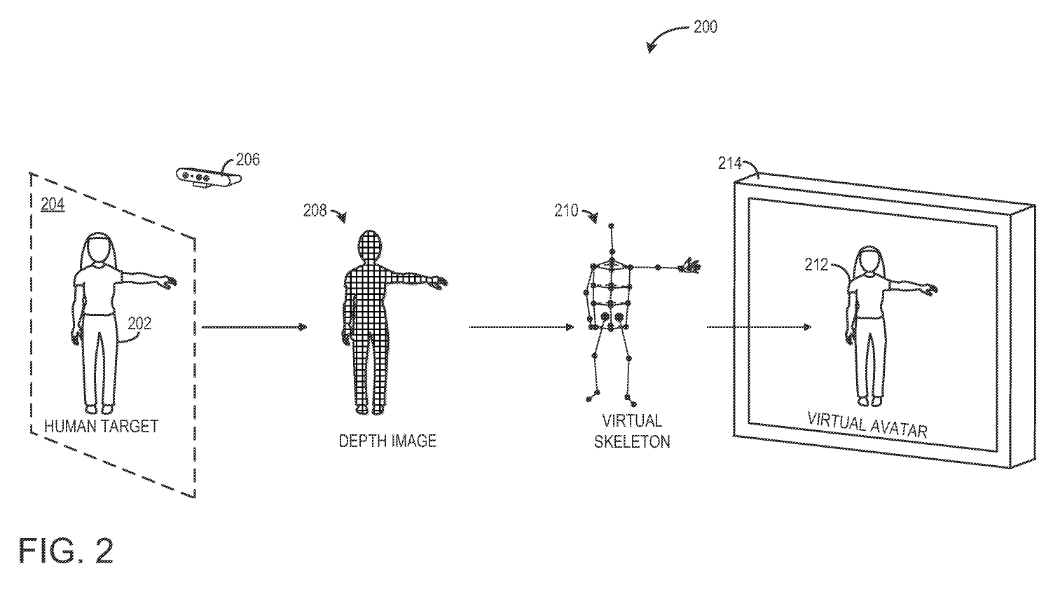

Use environment 100 further comprises a user client 106 that is configured to receive inputs from one or more imaging sensors 108 monitoring user 102. Imaging sensors 108 may be configured to provide image data (e.g., depth images, segmented images, and color images in some embodiments) to user client 106. In order to monitor the one or more exercises, user client 106 and/or sensors 108 may utilize all or part of a skeletal tracking pipeline. An example pipeline will be discussed later in reference to FIG. 2. It will be understood that although an arm-based exercise is illustrated, the present disclosure may be applied, without departing from the scope of the present disclosure, to any suitable exercise for treating any suitable condition.

A display device 110 operatively connected to user client 106 is shown displaying an avatar 112 representing performance of an exercise by user 102. Avatar 112 may substantially mirror the motion of user 102 to provide visual feedback to user 102. While illustrated as an image of user 102 based on a pre-configured avatar associated with the user, it will be understood that avatar 112 may comprise any suitable appearance (e.g., image from sensors 108, image of physical therapist performing exercise, cartoon character, fantasy character, animal, and/or wire-frame model, and/or combination thereof) without departing from the scope of the present disclosure.

User client 106 may be further configured to provide feedback 114 to user 102 via display device 110. Any suitable feedback may be provided. For example, as illustrated, feedback 114 may comprise a graph representing a performance metric (e.g., degree of shoulder rotation) determined based on image data collected via imaging sensors 108 from one or more exercise sessions. Such metrics may, qualitatively and/or quantitatively, show user performance within in a single exercise session and/or across multiple sessions. Tracking metrics across multiple sessions may allow for trend monitoring, and may thus provide a more informative representation of user progress.

In some embodiments, feedback 114 may further comprise one or more visual features (e.g., an overlay on, or next to, avatar 112) depicting a performance goal (e.g., desired degree of rotation) and/or a representation of previous user performance (e.g., previous degree of rotation). The visual features may comprise computer generated features (e.g., lines, shading, etc.) and/or recorded media content (e.g., image and/or video of previous exercise performance). For example, in the case of the illustrated shoulder exercise, feedback 114 may comprise an overlay (e.g., generated line radiating from the shoulder) depicting an amount of rotation from one or more previous performances of the exercise. As another example, feedback 114 may comprise a “ghost image” (e.g., image of increased opacity) of user 102 over avatar 112 while the user moves in tandem with the avatar.

User client 106 also may provide non-visual feedback. For example, user client 106 may be configured to provide audible feedback (e.g., computer-generated speech, notification sounds, etc.) via one or more audio output devices (e.g., speakers of display device 110 and/or a headset worn by user 102). It will be understood that in some embodiments, different and/or additional feedback devices (e.g., haptic feedback devices) not illustrated in FIG. 1 may be utilized.

Use environment 100 further comprises an administrator client 116. Administrator client 116 may allow an administrator 104, e.g. a physical therapist, to prescribe exercise modules for a patient, and to receive prescription tracking data for monitoring and/or correcting exercise performance by user 102. Prescription tracking data may comprise any suitable data representing the performance of an exercise by a patient. For example, prescription tracking data may comprise image data (e.g., image data from sensors 108 and/or sensors 124) and/or one or more performance metrics determined from processing such image data. Administrator client 116 may be operatively connected to display device 118 in order to display image feedback 120 and/or graphical feedback 122 based upon the prescription tracking data.

As illustrated, image feedback 120 may comprise image data from imaging sensors 108 capturing the patient performing the exercise. In some embodiments, image feedback 120 may further comprise one or more visual features (e.g., overlays comprising lines and/or recorded images) similar to visual features described above in reference to feedback 114 provided to the patient. Such visual features may enhance the productivity of the therapist by allowing the therapist to easily and quickly comprehend patient progression (e.g., by comparing how the patient was able to move one week prior).

Graphical feedback 122 may comprise, for example, a graph, patient charts, and/or other information used by administrator 104 to evaluate and/or treat user 102. Graphical feedback 122 may be based on prescription tracking data, and may therefore represent an analysis of patient performance. While graphical feedback 122 is illustrated similarly to feedback 114, it will be understood that graphical feedback 122 may comprise any suitable information presented in any suitable format.

Administrator client 116 may be further operatively connected to imaging sensors 124. Imaging sensors 124 may be similar to imaging sensors 108. Imaging sensors 124 may be utilized, for example, by administrator 104 to demonstrate exercises to user 102. In some embodiments, imaging sensors 124 may be used to capture video images of exercises performed by a practitioner to define custom exercise modules. In some embodiments (e.g., where sensors 124 are located in a physical therapy office) sensors 124 also may be utilized to image performance of one or more exercises by user 102. For example, such imaging may be used during baseline testing (e.g., first performance of an exercise) and/or during follow-up visits.

Use environment 100 further comprises a network-accessible server 126. Server 126 may be configured, for example, to store exercise modules 128 and/or patient records 130 comprising information such as data (e.g., images, videos, and/or metrics) representing the performance of the one or more exercises by user 102.

Server 126 may further comprise an exercise service 132. Exercise service may be configured to perform various tasks related to the provision of assigned exercise modules and feedback. For example, exercise service 132 may be configured to provide one or more exercise modules 128 based on data stored within a patient record 130, and/or based upon an administrator user inputs (e.g., made via administrator client 116). As a more specific example, exercise service 132 may send assigned exercise modules to a patient upon receiving a prescription from a practitioner. If a patient record 130 comprises information regarding a pre-existing condition (e.g., previous injury, pregnancy, limited mobility) that may impact patient ability to complete one or more exercises represented by exercise modules 128, the exercise service 132 may be configured to send such information to the practitioner, and/or to adjust an assigned exercise. Such provision of exercise modules 128 will be discussed in greater detail below in reference to FIG. 5.

It will be understood that the processes described herein may be performed in a peer-to-peer environment in some embodiments. Thus, the above-described functions of server 126 may be performed, in whole or in part, by user client 106 and/or administrator client 116. User client 106, administrator client 116, and server 126 may be communicatively coupled via network 134 (e.g., the Internet). Network 134 may comprise any combination of networks and/or subnetworks configured to provide bidirectional communication.

FIG. 2 shows an example embodiment of a pipeline 200 for analyzing performance of one or more assigned exercises. The three-dimensional appearance of human subject 202 (e.g., user 102 and/or administrator 104 of FIG. 1) and the rest of an observed scene 204 around human subject 202 may be imaged by one or more sensors 206 (e.g., imaging sensors 108 and/or imaging sensors 124 of FIG. 1). The sensors may be configured to determine, for example, a three dimensional depth of each surface observed scene 204.

The three dimensional depth information determined for each pixel may be used to generate a depth image 208. Such a depth image may take the form of virtually any suitable data structure, including but not limited to a matrix that includes a depth value for each pixel of the observed scene. Depth image 208 is schematically illustrated as a pixelated grid of the silhouette of the human subject 202 and the remainder of observed scene 204. This illustration is for simplicity of understanding, rather than technical accuracy. It is to be understood that a depth image may include depth information for each individual pixel.

A virtual skeleton 210 may be derived from the depth image 208 to provide a machine readable representation of the human subject 202. In other words, the virtual skeleton 210 is derived from depth image 208 to model the human subject 202. The virtual skeleton 210 may be derived from the depth image 208 in any suitable manner. For example, one or more skeletal fitting algorithms may be applied to depth image 208.

The virtual skeleton 210 may include a plurality of joints, and each joint may correspond to a portion of the human subject 202. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.).

A virtual avatar 212 (e.g., avatar 112 of FIG. 1) may be generated from virtual skeleton 210 and displayed on display device 214 (e.g., display device 110 and/or display device 118 of FIG. 1). As described above in reference to avatar 112 of FIG. 1, avatar 212 may comprise any suitable appearance (e.g., humanoid, animal, fantasy character) and/or style (e.g., cartoon, wire-frame model). In some embodiments, avatar 212 may comprise one or more features of observed scene 204 (e.g., head of human subject 202).

It will be understood that pipeline 200 is presented for the purpose of example and is not intended to be limiting in any manner. For example, the present disclosure is compatible with virtually any skeletal modeling techniques. Furthermore, in some embodiments, different and/or additional pipeline stages may be utilized without departing from the scope of the present disclosure.

FIG. 3 shows a process flow depicting an embodiment of a method 300 for providing an interactive physical therapy experience to a patient via a computing device, such as user client 106 of FIG. 1. Method 300 comprises, at 302, receiving one or more exercise modules. For example, exercise modules may be downloaded to the user device from a network-accessible service, such as one running on server 126 and/or administrator client 116 of FIG. 1. In some embodiments, the exercise modules may be stored remotely and subsequently accessed on-demand (e.g., “streamed”) by the user device. In other embodiments, the exercise modules may be stored on one or more removable devices (e.g., flash drives, optical discs, etc.), and thus the exercise modules may be received by physically introducing the removable devices to the user device.

An exercise module, as mentioned above in reference to FIG. 1, represents an exercise to be performed by a user, such as user 102 of FIG. 1. Each exercise module may comprise any suitable data relating to the exercise, including but not limited to a virtual representation of the corresponding exercise (e.g., recorded performance of exercise) and/or module-specific feedback (e.g., customized overlays and/or customized alert sounds). The provision of exercise modules will be discussed in greater detail below.

At 304, method 300 comprises sending to a display device a virtual representation of each assigned exercise to demonstrate the corresponding exercise to the user. The virtual representation may comprise a generated performance by an on-screen avatar and/or a recorded performance (e.g., images and/or video of performance by a physical therapist). In some embodiments, the virtual representation may further comprise one or more auxiliary data (e.g., text, audio, and/or overlays) configured to provide additional information as to the proper completion of each assigned exercise.

At 306, method 300 comprises receiving data from one or more imaging sensors (e.g., imaging sensors 108 and/or imaging sensors 124 of FIG. 1) during user performance of each assigned exercise. The image data may be received in any suitable form. For example, the image data may be received as raw data, or following one or more pre-processing stages (e.g., filtering, smoothing, etc.).

At 308, method 300 comprises displaying feedback comprising an avatar representing the user performance. For example, in some embodiments, an avatar (e.g., avatar 112 of FIG. 1) may be displayed that substantially follows the motion of the user (e.g., user 102 of FIG. 1). Such an avatar may provide visual feedback to alert the user of any deficiencies in their performance (e.g., lack of extension, poor posture). Such an avatar also may be displayed in a superimposed image with an avatar that demonstrates the exercise.

In other embodiments, feedback may comprise additional and/or different features. For example, feedback may comprise tracking repetitions of an exercise, if appropriate. In other embodiments, feedback may comprise providing voice or image suggestions alerting the user to one or corrections to their performance of the exercises. As another example, feedback may comprise an achievement/reward system for performing exercises. As yet another example, feedback may comprise one or more mechanisms configured to convey completion (and alternately lack of completion) of the one or more assigned exercises. It will be understood that these scenarios presented for the purpose of example, and that feedback may comprise any mechanism or combination of mechanisms without departing from the scope of the present disclosure.

At 310, method 300 comprises sending prescription tracking data (e.g. to an exercise service and/or to an administrative client device) representing the image data received at 306. Tracking data may comprise any data including, but not limited to, the image data itself (e.g., recorded images and/or video) and one or more performance metrics based on the image data. Performance metrics may be qualitative (e.g., performance quality score) and/or quantitative (e.g., degree of rotation, number of repetitions completed, change versus previous measurements, etc.). It will be understood that the tracking data may be comprise raw data and/or analyzed data.

Tracking data may be sent in response to one or more criteria. For example, tracking data may be sent according to a pre-defined schedule (e.g., every day at midnight) and/or upon completion of one or more exercises. In some embodiments, tracking data may be sent upon detection of one or more warning signs. For example, detection of decreased mobility in one or more extremities may be symptomatic of one or more health conditions, and may therefore trigger sending of prescription tracking data. It will be understood that such warning signs may be detected outside the treatment scope. For example, if treatment is being provided for an arm injury, warning signs may be detected in the legs, back, etc.

As mentioned above, prescription tracking data may be sent to a physical therapist's computing device (e.g., administrator client 116 of FIG. 1) and/or may be sent to a server (e.g., server 126 of FIG. 1) for later consumption and/or archiving as part of a patient record. Prescription tracking data may be sent via one or more transfer protocols (e.g., HTTP, FTP, peer-to-peer protocols), e-mail, and/or any other suitable mechanism or combination of mechanisms.

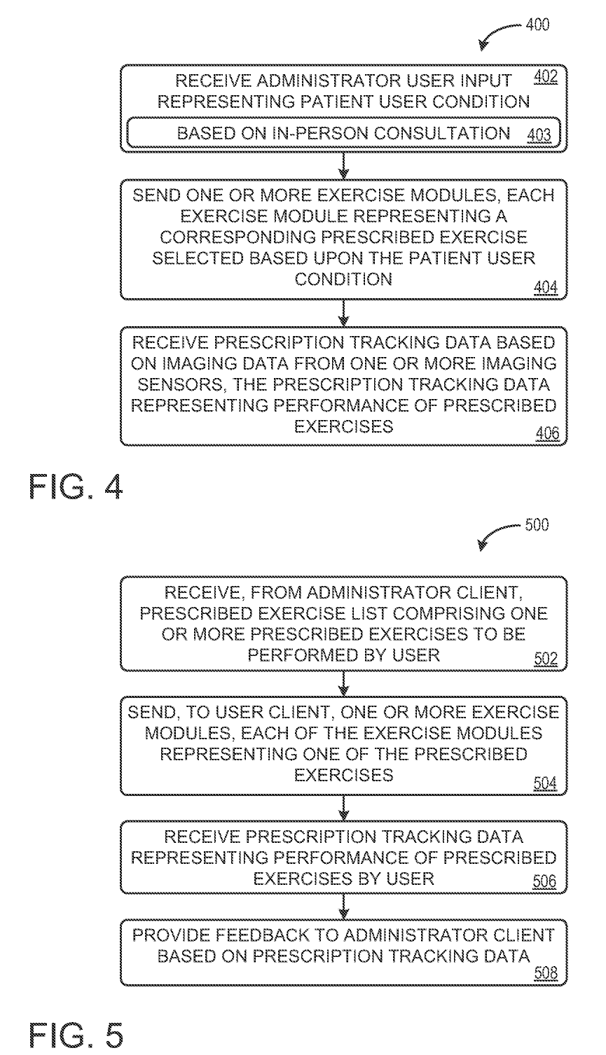

FIG. 4 shows a process flow depicting an embodiment of a method 400 for providing an interactive physical therapy experience to a practitioner via an administrator client. At 402, method 400 comprises receiving an administrator user input representing a patient user condition (e.g., injury). The administrator user input may be stored as part of a patient record (e.g., patient record 130 of FIG. 1). In some embodiments, the administrator user input may be utilized in determine one or more exercise modules.

The administrator user input may be based upon a physical evaluation of the patient, and/or may comprise sensor data capturing the physical evaluation of the patient. For example, as indicated at 403, the administrator user input may be based exercises assigned base upon on an in-person consultation with an administrator (e.g., physician, physical therapist, personal trainer, etc.). As mentioned above, such a consultation may provide an opportunity for diagnosis, discussion, demonstration and instruction. In some embodiments, the administrator user input may comprise further imaging data capturing the administrator user (e.g., practitioner) demonstrating an exercise to be performed by the patient. In other embodiments, the administrator user input may comprise a practitioner-defined assigned exercise list.

At 404, method 400 comprises sending, to a remote computing device (e.g., user client 106 and/or server 126), data representing one or more exercise modules, each of the exercise modules representing a corresponding assigned exercise selected based upon the patient user condition. Server-side provision of exercise modules will be discussed in greater detail below in reference to FIG. 5.

Exercise modules may take any suitable form and be provided in any suitable manner. For example, in some embodiments, a physical therapist may have access to a standardized library of pre-configured exercise modules. Such exercise modules may comprise image data showing an exercise being performed, and/or may comprise skeletal modeling data that may be used to render an image of an avatar performing the exercise. As another example, new/customized exercises may be performed by the physical therapist for capture by imaging sensors (e.g., imaging sensors 124 of FIG. 1). The image data from said imaging sensors may then be utilized to programmatically generate an exercise module. As yet another example, exercises may be generated via user input (e.g., via mouse, keyboard, touch screen, etc.) to a software application. Said software application may provide, for example, a wire-frame skeletal model that can be manipulated (e.g., joints can be moved) to define motion of a given exercise. It will be understood that these scenarios are presented for the purpose of example, and that exercise modules may be defined via any suitable mechanism or combination of mechanisms without departing from the scope of the present disclosure.

At 406, method 400 comprises receiving, from the remote computing device, prescription tracking data based on image data from one or more imaging sensors (e.g., imaging sensors 108 of FIG. 1), the prescription tracking data representing performance of the one or more assigned exercises. Prescription tracking data may comprise one or more qualitative metrics (e.g., performance quality score) and/or quantitative metrics (e.g., number of repetitions, degree of rotation, etc.). Said prescription tracking data may then be presented (e.g., via display device 118 of FIG. 1) via any suitable mechanism or combination of mechanisms (e.g., graph, overlays, tables, etc.).

Providing tracking data to the practitioner may allow patient progress to be tracked between office visits, and also may facilitate timely diagnosis of additional problems that may require skilled human diagnosis. For example, one or more symptoms of a condition may not be detectable via imaging sensors due to device constraints (e.g., resolution of imaging sensors) and/or deficiencies in software models (e.g., no definition exists to recognize a given problem). In some embodiments, the provision of tracking data may be defined by user input from the physical therapist. For example, in some instances (e.g., catastrophic injury), greater human oversight may be desirable, and thus tracking data may provided in greater quality, quantity and/or frequency. In other embodiments, such provision may defined by each exercise module. For example, exercise modules defining exercises that are less complex and/or less important may be configured to provide less data as compared to exercise modules defining more “critical” exercises.

FIG. 5 shows a process flow depicting an embodiment of a method 500 for providing an interactive physical therapy experience via a network-accessible service, such as exercise service 132 of FIG. 1. At 502, method 500 comprises receiving, from an administrator client (e.g., administrator client 116 of FIG. 1), an assigned exercise list comprising representations of one or more assigned exercises to be performed by a user (e.g., user 102 of FIG. 1). The assigned exercise list may be represented as exercise modules uploaded by the administrator client, may be a list of exercise modules stored on the administrator client to be sent to a user client, or may take any other suitable form.

At 504, method 500 comprises sending, to a user client (e.g., user client 106 of FIG. 1), one or more exercise modules (e.g., exercise modules 128 of FIG. 1), each of the exercise modules representing one of the assigned exercises. The exercise modules may be selected in any suitable manner.

For example, the one or more exercise modules may be based on one or more patient data (e.g., patient data of patient records 130 of FIG. 1). Said patient data may comprise information regarding one or more patient characteristics and/or pre-existing conditions that may impact their ability to complete one or more exercises. For example, if a patient has known back problems, the one or more exercise modules sent to the user client may comprise exercise modules that do not require bending of the spine.

Exercise modules may be categorized (e.g., via embedded metadata) according to treatment area (e.g., cardio/pulmonary, electrophysiology, geriatric, integumentary, neurological, orthopedic, vestibular, pediatric), ailment (e.g., high ankle sprain, rotator cuff injury, torn ACL), gender, sport (e.g., when used in a physical fitness scenario), and/or other identifiers. Accordingly, one or more exercise modules may be programmatically compiled into an assigned exercise list according to an administrator user input representing a patient user condition (e.g., injury type). For example, input of a shoulder injury may result in an exercise list comprising one or more exercise modules applicable to a shoulder injury.

In some embodiments, provision of exercise modules, may be at least partially programmatically determined via image data received from the administrative client. In such embodiments, a patient may be imaged by one or more imaging sensors (e.g., imaging sensors 108 and/or imaging sensors 124 of FIG. 1) during the performance of one or more exercises and/or other diagnostic activities. One or more modules may therefore be determined based on the data from the one or more imagine sensors. It will be understood that such processes also may be performed via the administrative client.

At 506, method 500 comprises receiving prescription tracking data representing performance of the one or more assigned exercises by the user. As described above in reference to FIG. 4, prescription tracking data may comprise raw or processed image data, and/or one or more qualitative metrics (e.g., performance quality score) and/or quantitative metrics (e.g., number of repetitions, degree of rotation, etc.) determined from image data. At 508, method 500 comprises providing feedback to the administrator client based on the prescription tracking data.

In some embodiments, the above described methods and processes may be tied to a computing system including one or more computers. In particular, the methods and processes described herein may be implemented as a computer application, computer service, computer API, computer library, and/or other computer program product.

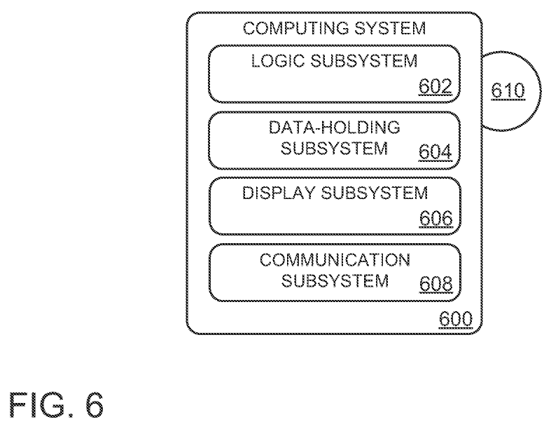

FIG. 6 schematically shows a non-limiting computing system 600 that may perform one or more of the above described methods and processes. Computing system 600 is shown in simplified form. User client 106, administrator client 116, and server 126 of FIG. 1 are non-limiting examples of computing system 600. It is to be understood that virtually any computer architecture may be used without departing from the scope of this disclosure. In different embodiments, computing system 600 may take the form of a mainframe computer, server computer, desktop computer, laptop computer, tablet computer, home entertainment computer, network computing device, mobile computing device, mobile communication device, gaming device, etc.

Computing system 600 includes a logic subsystem 602 and a data-holding subsystem 604. Computing system 600 may optionally include a display subsystem 606, communication subsystem 608, and/or other components not shown in FIG. 4. Computing system 600 may also optionally include user input devices such as keyboards, mice, game controllers, cameras, microphones, and/or touch screens, for example.

Logic subsystem 602 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 604 may include one or more physical, non-transitory, devices configured to hold data and/or instructions executable by the logic subsystem to implement the herein described methods and processes. When such methods and processes are implemented, the state of data-holding subsystem 604 may be transformed (e.g., to hold different data).

Data-holding subsystem 604 may include removable media and/or built-in devices. Data-holding subsystem 604 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 604 may include devices with one or more of the following characteristics: volatile, nonvolatile, dynamic, static, read/write, read-only, random access, sequential access, location addressable, file addressable, and content addressable. In some embodiments, logic subsystem 602 and data-holding subsystem 604 may be integrated into one or more common devices, such as an application specific integrated circuit or a system on a chip.

FIG. 4 also shows an aspect of the data-holding subsystem in the form of removable computer-readable storage media 610, which may be used to store and/or transfer data and/or instructions executable to implement the herein described methods and processes. Removable computer-readable storage media 610 may take the form of CDs, DVDs, HD-DVDs, Blu-Ray Discs, EEPROMs, and/or floppy disks, among others.

It is to be appreciated that data-holding subsystem 604 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 600 that is implemented to perform one or more particular functions. In some cases, such a module, program, or engine may be instantiated via logic subsystem 602 executing instructions held by data-holding subsystem 604. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 606 may be used to present a visual representation of data held by data-holding subsystem 604. As the herein described methods and processes change the data held by the data-holding subsystem, and thus transform the state of the data-holding subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or data-holding subsystem 604 in a shared enclosure, or such display devices may be peripheral display devices.

When included, communication subsystem 608 may be configured to communicatively couple computing system 600 with one or more other computing devices. Communication subsystem 608 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 600 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a logic subsystem; and
a data-holding subsystem comprising instructions stored thereon that are executable by the logic subsystem to:
receive, from an administrator client, an assigned exercise list comprising one or more assigned exercises to be performed by a user;
send, to a user client, one or more exercise modules, each of the exercise modules representing one of the assigned exercises;
receive prescription tracking data representing performance of the one or more assigned exercises by the user; and
provide feedback to the administrator client based on the prescription tracking data.

2. The computing device of claim 1, wherein the prescription tracking data comprises image data from one or more imaging sensors.

3. The computing device of claim 2, wherein the image data comprises one or more of a color image, a depth image, and a segmented image.

4. The computing device of claim 2, wherein the prescription tracking data further comprises one or more performance metrics based on the image data.

5. The computing device of claim 4, wherein the one or more performance metrics comprises one or more of a quantitative metric and a qualitative metric.

6. The computing device of claim 1, wherein the feedback comprises data representing an analysis of patient performance for one or more of exercise modules for presentation by the administrator client.

7. The computing device of claim 1, the instructions being further executable to store the prescription tracking data in a patient record.

8. A computing device, comprising:
a logic subsystem; and
a data-holding subsystem comprising instructions stored thereon that are executable by the logic subsystem to:
receive an administrator user input representing a patient user condition;
send, to a remote computing device, one or more exercise modules, each of the exercise modules representing a corresponding assigned exercise selected based upon the patient user condition; and
receive, from the remote computing device, prescription tracking data based on image data from one or more imaging sensors, the prescription tracking data representing performance of the one or more assigned exercises.

9. The computing device of claim 8, wherein the image data comprises depth image data.

10. The computing device of claim 8, wherein the image data comprises color image data.

11. The computing device of claim 8, wherein the input regarding the patient user condition comprises a practitioner-defined assigned exercise list.

12. The computing device of claim 8, wherein the input further comprises imaging data capturing a practitioner demonstrating an exercise to be performed by the patient.

13. The computing device of claim 8, wherein the one or more exercise modules are determined based on the input regarding the patient user condition.

14. The computing device of claim 8, wherein the instructions are further executable to output to a display device feedback based on the prescription tracking data.

15. On a computing device, a method for providing an interactive physical therapy experience to a user, the method comprising:
receiving one or more exercise modules, each of the modules representing an assigned exercise to be performed by the user;
outputting to a display device a virtual representation of each of the assigned exercises;
receiving data from one or more imaging sensors during user performance of each of the assigned exercises;
outputting to the display device feedback comprising an avatar representing the user performance; and
sending prescription tracking data representing the image data.

16. The method of claim 15, wherein receiving the one or more exercise modules comprises downloading the one or more modules from a remote server.

17. The method of claim 15, wherein receiving the one or more exercises modules comprises streaming the one or more modules on-demand from a remote server.

18. The method of claim 15, wherein the virtual representation comprises one or more of a recorded performance by an administrator and a generated performance by a virtual avatar.

19. The method of claim 15, wherein the feedback comprises a representation of a previous user performance.

20. The method of claim 15, wherein the feedback comprises a performance goal.
